(19) United States
(12) Patent Application Publication
(10) Pub. No.: US 2024/0261161 A1
(43) Pub. Date: Aug. 8, 2024

(54) ELECTRIC WHEELCHAIR

(71) Applicant: JTEKT CORPORATION, Kariya-shi (JP)

(72) Inventors: Nobuyuki TOGASHI, Kashihara-shi (JP); Hiroshi KITAMOTO, Toyota-shi (JP); Nobuaki IKEHARA, Kashiba-shi (JP); Riku NAGAYAMA, Ikoma-gun (JP); Chishin YOHENA, Okinawa-shi (JP)

(73) Assignee: JTEKT CORPORATION, Kariya-shi (JP)

(21) Appl. No.: 18/426,445

(22) Filed: Jan. 30, 2024

(30) Foreign Application Priority Data
Feb. 6, 2023 (JP) 2023-016061

(51) Int. Cl. A61G 5/04

(52) U.S. Cl. CPC A61G 5/048

(57) ABSTRACT

An electric wheelchair includes: a vehicle body; a first drive wheel; a second drive wheel; a first motor; a second motor; a first grip; a second grip; a first operation detection unit configured to detect a position of the first grip in a front-rear direction; a second operation detection unit configured to detect a position of the second grip in the front-rear direction; a first rotation speed detection unit; a second rotation speed detection unit; and a controller. The controller is configured to control the first motor and the second motor so as to turn the vehicle body, based on a difference between a displacement amount of the first grip and a displacement amount of the second grip and a difference between a rotation speed of the first drive wheel and a rotation speed of the second drive wheel.

### CROSS-REFERENCE TO RELATED APPLICATION

This application claims priority to Japanese Patent Application No. 2023-016061 filed on Feb. 6, 2023, incorporated herein by reference in its entirety.

### BACKGROUND

### 1. Technical Field

The present disclosure relates to an electric wheelchair.

### 2. Description of Related Art

Japanese Unexamined Patent Application Publication No. 10-336803 describes an electric wheelchair configured to give a propulsion force depending on the operation of an operator. In the electric wheelchair, grips that are grasped by the operator are provided so as to be capable of moving in a front-rear direction, and the propulsion force is given depending on displacements of the grips. Further, when there is a difference between right and left operation forces, right and left motors are driven such that the electric wheelchair is turned.

### SUMMARY

On a flat road, the electric wheelchair is turned when the operator intendedly performs a turning operation. On the other hand, on a road surface having an inclination in a right-left direction, for example, on a canted road, even when the operator does not perform the operation, a vehicle body acts so as to be turned by the self-weight, so that the vehicle body easily wobbles. Hence, assuming traveling on a road surface such as a canted road, it is desirable to improve the operability for the operator.

The present disclosure provides an electric wheelchair having high operability.

An electric wheelchair according to an aspect of the present disclosure includes a vehicle body, a first drive wheel, a second drive wheel, a first motor, a second motor, a first grip, a second grip, a first operation detection unit, a second operation detection unit, a first rotation speed detection unit, a second rotation speed detection unit, and a controller. The first drive wheel is disposed on one of right and left sides of the vehicle body, and is configured to cause the vehicle body to travel. The second drive wheel is disposed on the other of the right and left sides of the vehicle body, and is configured to cause the vehicle body to travel. The first motor is configured to drive the first drive wheel. The second motor is configured to drive the second drive wheel. The first grip is disposed on the one of the right and left sides of the vehicle body so as to be grasped by an operator, and is configured to be displaced in a front-rear direction of the vehicle body by operation of the operator. The second grip is disposed on the other of the right and left sides of the vehicle body so as to be grasped by the operator, and is configured to be displaced in the front-rear direction of the vehicle body by operation of the operator. The first operation detection unit is configured to detect a position of the first grip in the front-rear direction. The second operation detection unit is configured to detect a position of the second grip in the front-rear direction. The first rotation speed detection unit is configured to detect a rotation speed of the first drive wheel. The second rotation speed detection unit is configured to detect a rotation speed of the second drive wheel. The controller is configured to control the first motor and the second motor so as to turn the vehicle body, based on a difference between a displacement amount of the first grip and a displacement amount of the second grip and a difference between the rotation speed of the first drive wheel and the rotation speed of the second drive wheel.

With the electric wheelchair in the above-described aspect, the controller controls the first motor and the second motor so as to turn the vehicle body, based on the difference between the displacement amount of the first grip and the displacement amount of the second grip and the difference between the rotation speed of the first drive wheel and the rotation speed of the second drive wheel.

For example, in the case where the turning of the vehicle body is started on the flat road, the difference between the rotation speed of the first drive wheel and the rotation speed of the second drive wheel is zero before the turning, and therefore the controller controls the first motor and the second motor, based on the difference between the displacement amount of the first grip and the displacement amount of the second grip. Thereby, the vehicle body is turned depending on the grip operation of the operator. In this case, the turning operation can be stably performed.

Further, in the case where the vehicle body continues to be turned on the flat road, the difference between the rotation speed of the first drive wheel and the rotation speed of the second drive wheel has been already generated. Accordingly, the controller controls the first motor and the second motor, based on the difference between the displacement amount of the first grip and the displacement amount of the second grip, in consideration of the difference between the rotation speed of the first drive wheel and the rotation speed of the second drive wheel. Thereby, the vehicle body continues to be turned depending on the grip operation of the operator. Also in this case, the turning operation can be stably performed.

Further, on a canted road having an inclination in the right-left direction, the vehicle body is about to be turned by the self-weight, due to the influence of the inclination. Thereby, the difference between the rotation speed of the first drive wheel and the rotation speed of the second drive wheel is generated. In this case, the controller controls the first motor and the second motor, based on the difference between the displacement amount of the first grip and the displacement amount of the second grip, in consideration of the difference between the rotation speed of the first drive wheel and the rotation speed of the second drive wheel due to the influence of the canted road. Accordingly, even when the road surface is the canted road, the operation of the operator can be suitably performed.

In the electric wheelchair according to the aspect of the present disclosure, the controller may be configured to generate a turning speed command value of the vehicle body, based on the difference between the displacement amount of the first grip and the displacement amount of the second grip. The controller may be configured to calculate a yaw rate of the vehicle body, based on the difference between the rotation speed of the first drive wheel and the rotation speed of the second drive wheel. The controller may be configured to calculate a turning torque of the vehicle body, based on a value resulting from subtracting the yaw rate from the turning speed command value. The controller may be configured to generate a speed command value of the first motor and a speed command value of the second motor, based on the turning torque. The speed command value of the first motor and the speed command value of the second motor may be speed command values for turning the vehicle body. The controller may be configured to control the first motor and the second motor, based on the speed command value of the first motor and the speed command value of the second motor, respectively.

In the electric wheelchair according to the aspect of the present disclosure, the controller may be configured to calculate a propulsion force of the vehicle body, based on a sum of the displacement amount of the first grip and the displacement amount of the second grip. The controller may be configured to generate the speed command value of the first motor and the speed command value of the second motor, based on the propulsion force and the turning torque.

In the electric wheelchair according to the aspect of the present disclosure, the controller may be configured to calculate an external force that the vehicle body receives from outside, based on a motor current of the first motor and a motor current of the second motor. The controller may be configured to generate the speed command value of the first motor and the speed command value of the second motor, by subtracting the turning torque and the external force from the propulsion force.

With the electric wheelchair according to the aspect of the present disclosure, it is possible to provide the electric wheelchair having high operability.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of an electric wheelchair according to an embodiment;

FIG. 2 is a diagram of a drive unit disposed on the right side of a vehicle body, as viewed from the center of the vehicle body in a right-left direction;

FIG. 3A is a sectional view of a first operation unit;

FIG. 3B is a sectional view of the first operation unit;

FIG. 3C is a sectional view of the first operation unit;

FIG. 4 is a block diagram showing an exemplary configuration for controlling actions of motors in the electric wheelchair;

FIG. 5 is a diagram for describing a control logic of a drive mechanism by a controller;

FIG. 6 is a diagram schematically showing a manner when an operator operates the electric wheelchair;

FIG. 7 is a diagram for describing a non-grasp determination region of grips;

FIG. 8 is a flowchart showing a non-grasp determination process;

FIG. 9 is a diagram showing a manner when the electric wheelchair is turned, as viewed from above the vehicle; and

FIG. 10 is a diagram showing a manner when the electric wheelchair travels on a canted road, as viewed from behind the vehicle.

### DETAILED DESCRIPTION OF EMBODIMENTS

An electric wheelchair that is an embodiment of the above-described aspect will be described below with reference to the drawings.

### Embodiment

### 1. Overall Structure of Electric Wheelchair 1

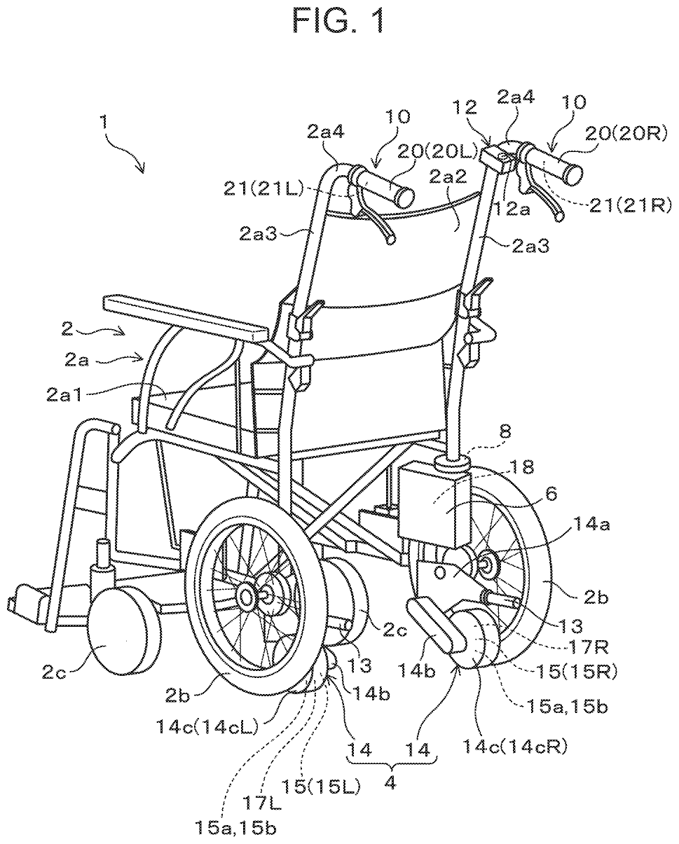

As shown in FIG. 1, an electric wheelchair 1 in the embodiment is an electric vehicle that travels by the operation of an operator. The traveling of the electric wheelchair 1 is assisted by drive wheels 14c that is electrically driven.

The electric wheelchair 1 includes a wheelchair unit 2, a drive mechanism 4, a control box 6, a first operation unit 10, and a second operation unit 12. The wheelchair unit 2 is a general wheelchair, and includes mainly a vehicle body 2a constituted by frames such as metal pipes, a pair of main wheels 2b, and a pair of casters 2c. The casters 2c are provided on both of the right and left sides of the vehicle body 2a. The main wheels 2b also are provided on both of the right and left sides of the vehicle body 2a. The main wheels 2b are provided rearward of the casters 2c. Consequently, the main wheels 2b are rear wheels. Further, the casters 2c are front wheels.

The vehicle body 2a includes a seat portion 2a1 on which a passenger sits, and a backrest portion 2a2. The vehicle body 2a includes a pair of right and left support pipes 2a3. The support pipes 2a3 support the backrest portion 2a2. A pair of protrusion portions 2a4 is provided at upper ends of the support pipes 2a3. The protrusion portions 2a4 protrudes from the backrest portion 2a2 rearward. The protrusion portions 2a4 are pipes that have openings at rear ends. A pair of first operation units 10 is provided at the protrusion portions 2a4. Consequently, the first operation units 10 are disposed above the right and left sides of the backrest portion 2a2. Each of the first operation units 10 includes a grip 20. The grip 20 on the left side is a first grip 20L that is disposed on the left side of the vehicle body 2a so as to be capable of being grasped by the operator. The grip 20 on the right side is a second grip 20R that is disposed on the right side of the vehicle body 2a so as to be capable of being grasped by the operator.

A second operation unit 12 is provided at the protrusion portion 2a4 on the right side. A plurality of operation switches 12a for accepting the operation of the operator is provided on the second operation unit 12. The plurality of operation switches 12a includes an operation switch for turning an electric power source on and off, and an operation switch for switching the state of the drive mechanism 4 between a state where the assist of the action of the electric wheelchair 1 is started and a state where the assist is ended.

Hereinafter, a direction (a direction in which the backrest portion 2a2 is oriented to the front face) in which the front face of the passenger is oriented when the passenger rides on the electric wheelchair 1 is referred to as a forward direction, and the opposite direction is referred to as a rearward direction. Consequently, the passenger rides so as to orient forward of the electric wheelchair 1. Further, the direction of the left side of the passenger is referred to as a leftward direction, and the direction of the right side of the passenger is referred to as a rightward direction.

The drive mechanism 4 includes a pair of drive units 14. The drive units 14 are fixed to the right and left sides of the vehicle body 2a. The drive units 14 are disposed on vehicle insides of the main wheels 2b. Each of the right and left drive units 14 includes a base plate 14a, an arm 14b, a drive wheel 14c, a motor 15, and a tipping bar 13.

### 2. Structure of Drive Unit 14

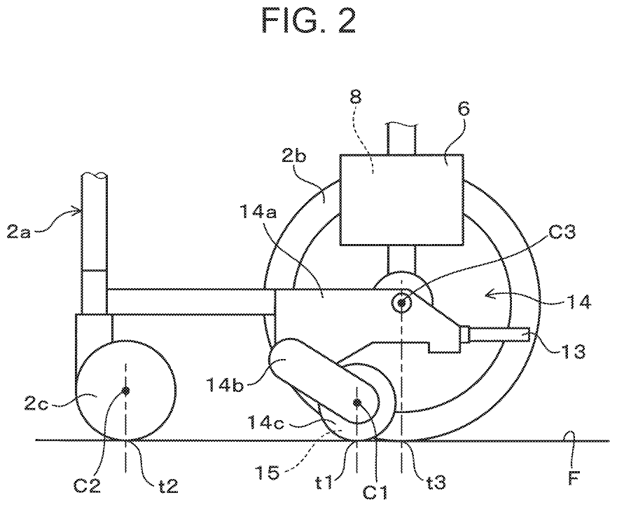

As shown in FIG. 1 and FIG. 2, the base plate 14a is fixed to the frame of the vehicle body 2a. Thereby, the drive unit 14 is put on the wheelchair unit 2. The tipping bar 13 is provided at a rear end of the base plate 14a. The tipping bar 13 is a member that is trodden by a foot of the operator that operates the electric wheelchair 1 from behind when the electric wheelchair 1 passes over a step. When the operator treads the tipping bar 13, the casters 2c are lifted upward while the main wheels 2b are support points.

The arm 14b is provided on the vehicle inside of the base plate 14a. The arm 14b is fixed to the base plate 14a, so as to be capable of swinging in an up-down direction. The arm 14b can swing in a predetermined angular range. The motor 15 and the drive wheel 14c are provided at a distal end portion of the arm 14b. The arm 14b supports the drive wheel 14c in a rotatable manner. The arm 14b elastically biases the drive wheel 14c in the downward direction. Thereby, the arm 14b causes the drive wheel 14c to contact with a road surface by pressing.

The motor 15 is an in-wheel motor, and is provided in the interior of the drive wheel 14c. A rotor (not illustrated) included in the motor 15 can rotate integrally with the drive wheel 14c. Further, a stator (not illustrated) included in the motor 15 is fixed to the arm 14b side. Thereby, the motor 15 drives and rotates the drive wheel 14c. The motor 15 is connected to a battery, a controller and others in the control box 6, through a cable (not illustrated). The cable is inserted into the arm 14b, and connects the motor 15 and the control box 6. The control box 6 is fixed to a frame portion on the right side of a portion under the seat portion 2a1. The control box 6 houses the battery, the controller that controls parts, and others. The motor 15 that drives the drive wheel 14c on the left side is a first motor 15L, and the motor 15 that drives the drive wheel 14c on the right side is a second motor 15R.

The drive wheel 14c is supported by the arm 14b, so as to be capable of rotating around a rotation axis C1 (see FIG. 2) parallel to a right-left direction. The drive wheel 14c is driven and rotated by the motor 15, in a state where the drive wheel 14c contacts with the road surface. The right and left motors 15 drive the right and left drive wheels 14c, and thereby the wheelchair unit 2 (the vehicle body 2a) travels. The drive wheel 14c on the left side is a first drive wheel 14cL disposed on the left side of the vehicle body 2a for the traveling of the vehicle body 2a. The drive wheel 14c on the right side is a second drive wheel 14cR disposed on the right side of the vehicle body 2a for the traveling of the vehicle body 2a.

As shown in FIG. 2, the drive wheel 14c is disposed between the caster 2c and the main wheel 2b. More specifically, the position of the rotation axis C1 in a front-rear direction is between a rotation axis C2 of the caster 2c and a rotation axis C3 of the main wheel 2b. Consequently, a contact position t1 of the drive wheel 14c on a road surface F is between a contact position t2 of the caster 2c and a contact position t3 of the main wheel 2b. The contact position t1 of the drive wheel 14c only needs to be in a range from the contact position t2 to the contact position t3. In other words, the position of the rotation axis C1 in the front-rear direction only needs to be in a range from the position of the rotation axis C2 to the position of the rotation axis C3.

### 3. Structure of First Operation Unit 10

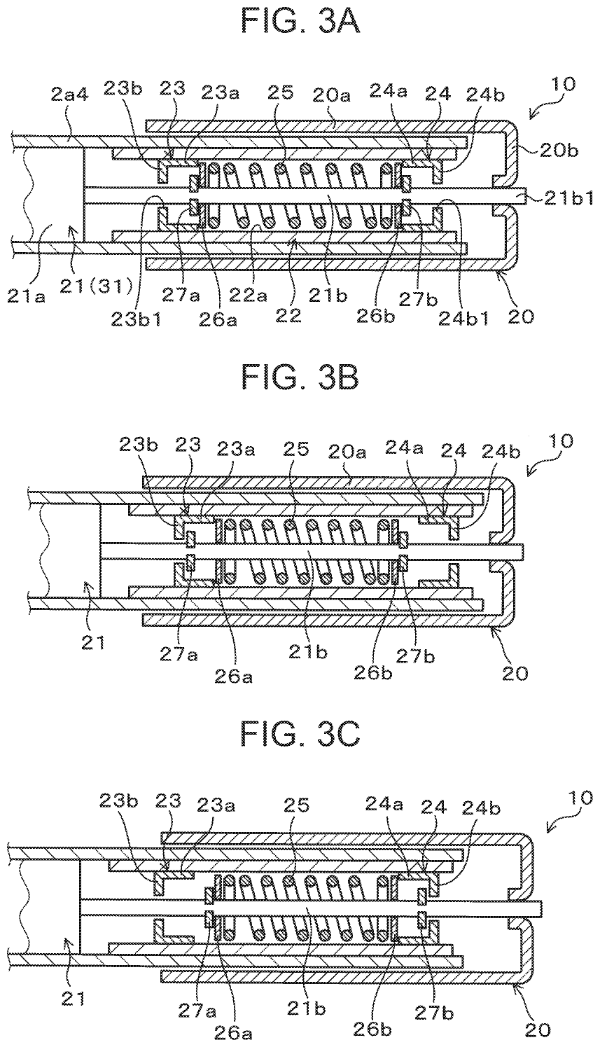

As shown in FIG. 3A, the first operation unit 10 includes an operation detection unit 21, in addition to the grip 20. The grip 20 is put at a distal end portion of the protrusion portion 2a4 on the vehicle left side. The grip 20 includes a tube portion 20a and a bottom portion 20b. The bottom portion 20b closes an opening on the rear side of the tube portion 20a. The tube portion 20a is put on an outer circumference side of the protrusion portion 2a4. The tube portion 20a can move while sliding on an outer circumference surface of the protrusion portion 2a4. Consequently, the grip 20 can move along the axis direction of the protrusion portion 2a4. The protrusion portion 2a4 extends along the front-rear direction. Consequently, the grip 20 can be grasped by the operator, and can be displaced in the front-rear direction with respect to the vehicle body 2a, by the operation of the operator.

The operation detection unit 21 has a function to detect the position and displacement amount of the grip 20 in the front-rear direction, as information about the displacement of the grip 20 in the front-rear direction. Further, the operation detection unit 21 has a function to detect information about the grasp of the grip 20 by the operator, from the information about the displacement of the grip 20 in the front-rear direction. Therefore, the operation detection unit 21 is a state sensor that detects the state of the operation or grasp of the grip 20 by the operator. The information about the displacement of the first grip 20L on the left side is detected by the first operation detection unit 21L, and the information about the displacement of the second grip 20R on the right side is detected by the second operation detection unit 21R (see FIG. 1).

In the embodiment, the operation detection unit 21 is a potentiometer. The operation detection unit 21 is provided in the interior of the protrusion portion 2a4. The operation detection unit 21 includes a body portion 21a and a rod 21b. The body portion 21a is fixed to the protrusion portion 2a4. The rod 21b extends from the body portion 21a in the rearward direction. The rod 21b passes through the interior of the tube portion 20a and the protrusion portion 2a4. The rod 21b can move in the axis direction relative to the body portion 21a. The operation detection unit 21 detects and outputs the displacement amount of the rod 21b in the axis direction. A distal end portion 21b1 of the rod 21b is fixed to the bottom portion 20b. Consequently, the rod 21b moves in the front-rear direction integrally with the grip 20. Thereby, the operation detection unit 21 can detect the displacement amount of the grip 20 in the front-rear direction with respect to the vehicle body 2a. The operation detection unit 21 is connected to the later-described controller in the control box 6. The output of the operation detection unit 21 is given to the controller.

In the interior of the protrusion portion 2a4, a sleeve 22, a front bush 23, a rear bush 24, and a spring 25 are provided in addition to the above-described operation detection unit 21. The sleeve 22 is a cylindrical member, and is inserted and fixed along an inner circumference surface of the protrusion portion 2a4. The front bush 23, the rear bush 24, and the spring 25 are disposed on an inner circumference side of the sleeve 22.

The front bush 23 includes a cylinder portion 23a and a bottom portion 23b. The cylinder portion 23a is inserted and fixed along an inner circumference surface 22a of the sleeve 22. The bottom portion 23b is provided at a front-side opening of the cylinder portion 23a. The bottom portion 23b includes a center hole 23b1. The rod 21b is inserted into the center hole 23b1. The rear bush 24 includes a cylinder portion 24a and a bottom portion 24b. The cylinder portion 24a is inserted and fixed along the inner circumference surface 22a of the sleeve 22. The bottom portion 24b is provided at a rear-side opening of the cylinder portion 24a. The bottom portion 24b includes a center hole 24b1. The rod 21b is inserted into the center hole 24b1.

The spring 25 is disposed between the front bush 23 and the rear bush 24. Consequently, the rod 21b passes through the front bush 23, the rear bush 24, and the spring 25. The rod 21b is provided with a front retainer 26a, a front snap ring 27a, a rear retainer 26b, and a rear snap ring 27b. The front snap ring 27a is provided on the front side of the spring 25. The front snap ring 27a is fixed to the rod 21b. The front snap ring 27a is fit into a circumferential groove provided on the rod 21b. Consequently, the front snap ring 27a can move in the axis direction integrally with the rod 21b. The rear snap ring 27b is provided on the rear side of the spring 25. The rear snap ring 27b is also fixed to the rod 21b. The rear snap ring 27b is fit into a circumferential groove provided on the rod 21b. Consequently, the rear snap ring 27b can move in the axis direction integrally with the rod 21b. That is, the front snap ring 27a and the rear snap ring 27b are fixed to the rod 21b at a certain axis-directional interval.

The front retainer 26a, the rear retainer 26b, and the spring 25 are disposed between the front snap ring 27a and the rear snap ring 27b. The front retainer 26a and the rear retainer 26b are annular members through which the rod 21b passes. The front retainer 26a and the rear retainer 26b hold a front end surface and rear end surface of the spring 25. The front retainer 26a is interposed between the front bush 23 and the front end surface of the spring 25. The rear retainer 26b is interposed between the rear bush 24 and the rear end surface of the spring 25.

### 4. Neutral Position of Grip 20

FIG. 3A shows a case where the grip 20 is at a neutral position. The grip 20 is at the neutral position when the grip 20 is not grasped by the operator or when the operation force is not input by the operator. In the case where the grip 20 is at the neutral position, the spring 25 biases the front retainer 26a toward the front bush 23. Further, the spring 25 biases the rear retainer 26b toward the rear bush 24. At this time, the front retainer 26a abuts on the cylinder portion 23a of the front bush 23. Further, the rear retainer 26b abuts on the cylinder portion 24a of the rear bush 24. That is, in the case where the grip 20 is at the neutral position, the interval between the front retainer 26a and the rear retainer 26b is shorter than the free length of the spring 25.

### 5. Front-Side Position of Grip 20

FIG. 3B shows a case where the grip 20 has moved to a front-side position located forward of the neutral position. When the grip 20 moves from the neutral position forward, the rod 21b also moves forward. Thereby, the output of the operation detection unit 21 changes. When the grip 20 and the rod 21b move forward of the neutral position, the spring 25 is pressed forward by the rear retainer 26b and the rear snap ring 27b. Consequently, the rear retainer 26b gets away from the rear bush 24. When the grip 20 further moves forward, the front snap ring 27a abuts on the bottom portion 23b of the front bush 23, as shown in FIG. 3B. Thereby, the front snap ring 27a and the front bush 23 restrict the forward movement of the rod 21b.

### 6. Rear-Side Position of Grip 20

FIG. 3C shows a case where the grip 20 has moved to a rear-side position located rearward of the neutral position. When the grip 20 moves from the neutral position rearward, the rods 21b also moves rearward. Thereby, the output of the operation detection unit 21 changes. When the grip 20 and the rod 21b move rearward of the neutral position, the spring 25 is pressed rearward by the front retainer 26a and the front snap ring 27a. Consequently, the front retainer 26a gets away from the front bush 23. When the grip 20 further moves rearward, the rear snap ring 27b abuts on the bottom portion 24b of the rear bush 24, as shown in FIG. 3C. Thereby, the rear snap ring 27b and the rear bush 24 restrict the rearward movement of the rod 21b.

By the above configuration, the grip 20 can be elastically moved from the neutral position in the front-rear direction by the spring 25. Further, the movement range of the grip 20 and the rod 21b in the front-rear direction is restricted by the front bush 23, the rear bush 24, the front snap ring 27a, and the rear snap ring 27b.

### 7. Configuration of Electric Wheelchair 1

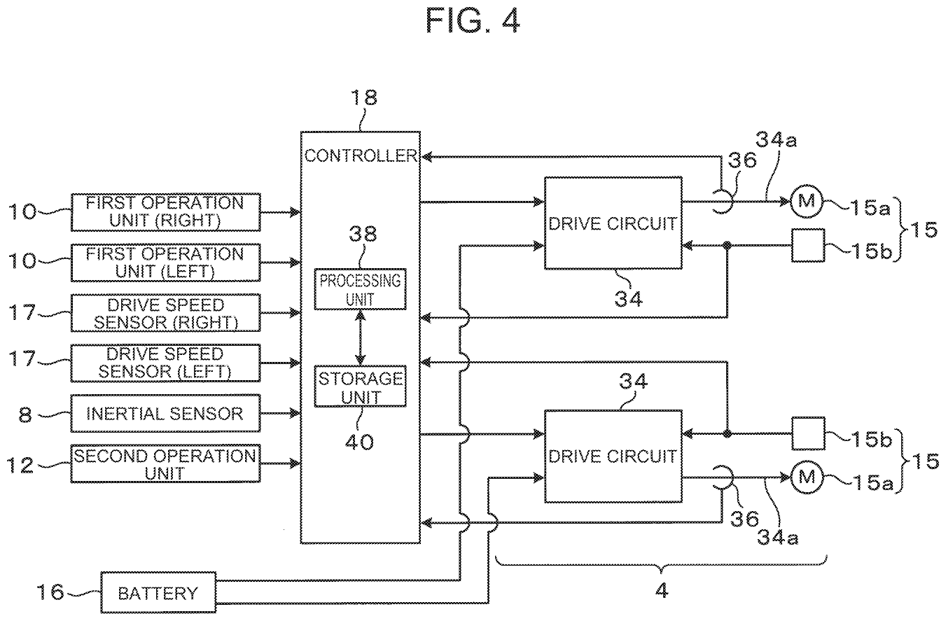

As shown in FIG. 4, the electric wheelchair 1 further includes right and left drive speed sensors 17, an inertial sensor 8, a battery 16, and a controller 18. Each of the inertial sensor 8, the battery 16, and the controller 18 is housed in the control box 6 (see FIG. 1).

The drive speed sensor 17 detects the drive speed of the drive wheel 14c. The drive speed sensor 17 is attached to the drive wheel 14c. The drive speed sensor 17 is electrically connected to the controller 18. Therefore, the output of the drive speed sensor 17 is given to the controller 18. From the drive speed of the drive wheel 14c, it is possible to calculate the traveling speed of the vehicle body 2a of the electric wheelchair 1. Therefore, the drive speed sensor 17 can be regarded as a traveling speed detection unit that detects the traveling speed of the vehicle body 2a of the electric wheelchair 1. The drive speed sensor 17 attached to the drive wheel 14c on the left side is a first rotation speed detection unit 17L, and the drive speed sensor 17 attached to the drive wheel 14c on the right side is a second rotation speed detection unit 17R (see FIG. 1).

The inertial sensor 8 detects information relevant to the inertia that acts on the vehicle body 2a. In the embodiment, for example, the inertial sensor 8 is an inertial measurement unit (IMU), and includes at least a three-axis acceleration sensor. The inertial sensor 8 is electrically connected to the controller 18. Therefore, the output of the inertial sensor 8 is given to the controller 18. Based on the output of the inertial sensor 8, the controller 18 evaluates the inclination angle of the vehicle body 2a in the front-rear direction. That is, the inertial sensor 8 functions as a sensor that detects the inclination angle of the vehicle body 2a in the front-rear direction.

The battery 16 supplies electric power to the motors 15 and parts that require action electric power. The controller 18 has a function to control the drive mechanism 4 (the motors 15) by giving command values to the drive mechanism 4, and to control the speed of the vehicle body 2a.

The drive mechanism 4 including the motors 15 includes a pair of drive circuits 34. Further, each of the motors 15 includes a motor body 15a and a rotation detector 15b. The motor body 15a includes a rotor, a stator and others, which are main components of the motor. For example, the rotation detector 15b is a Hall sensor provided at the motor body 15a. The rotation detector 15b detects the rotation angle of the rotor of the motor body 15a. The rotation detector 15b is connected to the drive circuit 34 and the controller 18. Therefore, the output of the rotation detector 15b is given to the drive circuit 34 and the controller 18. At this time, the rotation speed of the motor 15 is derived from the rotation angle of the rotor of the motor body 15a. Therefore, the rotation detector 15b has a function as a motor information detection unit that detects motor information relevant to the rotation speed of the motor 15. Further, the motor information detected by the rotation detector 15b is also information relevant to the rotation of the drive wheel 14c. Therefore, the rotation detector 15b can be regarded as a rotation information detection unit that detects the information relevant to the rotation of the drive wheel 14c.

For example, the drive circuits 34 are inverters. The drive circuits 34 may be housed in the control box 6, or may be provided on the base plate 14a or the arm 14b. The drive circuits 34 are connected to the controller 18, the battery 16, and the motors 15. The drive circuits 34 give the electric power of the battery 16 to the motors 15. The drive circuits 34 have a function to give drive electric power to the motors 15 based on speed command values given by the controller 18 and the outputs of the rotation detectors 15b, and to control the motors 15 such that rotation speeds indicated by the speed command values are achieved.

The drive circuits 34 and the motors 15 (the motor bodies 15a) are connected by a pair of electric power lines 34a. The electric power lines 34a are provided with a pair of current detection units 36. The current detection units 36 are current sensors that detect electric currents that flow through the electric power lines 34a. That is, the current detection units 36 detect motor currents that flow through the motors 15. The current detection units 36 are connected to the controller 18. Therefore, the outputs of the current detection units 36 are given to the controller 18.

The first operation units 10 and the second operation unit 12 are also connected to the controller 18. As described above, the outputs of the first operation units 10 (that is, the outputs of the operation detection units 21) and the output of the second operation unit 12 are given to the controller 18. In the embodiment, the outputs of the operation detection units 21 are defined as operation inputs of the grips 20 to the controller 18.

The controller 18 is configured, for example, by a computer including a processing unit 38 constituted by processor and others and a storage unit 40 constituted by a memory, a hard disk and others. In the storage unit 40, computer programs that are executed by the processing unit 38, and necessary information are stored. The processing unit 38 executes computer programs stored in a computer-readable non-transitory recording medium such as the storage unit 40, and thereby realizes various processing functions of the controller 18.

### 8. Configuration of Controller 18

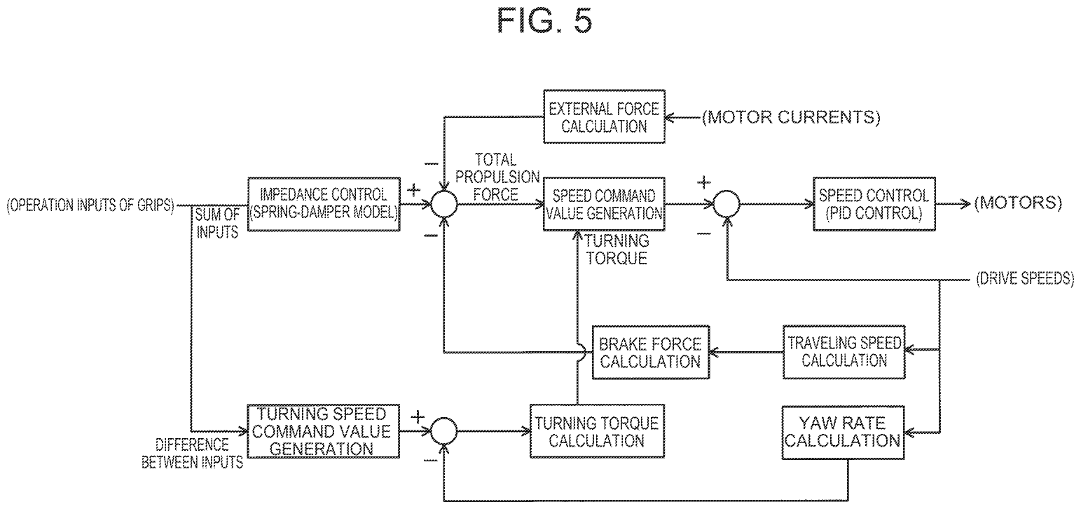

The controller 18 executes the control of the drive mechanism 4, in accordance with a control logic shown in FIG. 5.

An impedance control and a turning speed command value generation are executed based on the operation inputs (displacement amounts) of the grips 20. In the impedance control, a later-described spring-damper model is used. By the impedance control, a basic propulsion force is calculated based on the sum (the sum of the displacement amounts) of the operation inputs of the grips 20. Meanwhile, a turning speed command value is generated based on the difference between the operation inputs of the grips 20 (the difference between the displacement amounts). A total propulsion force is calculated by subtracting an external force and a brake force from the basic propulsion force. The external force is a force that the vehicle body 2a receives from the outside, and is calculated based on the motor currents detected by the current detection units 36 (see FIG. 4). The brake force is calculated using the traveling speed. The traveling speed is calculated from the drive speeds (rotation speeds) detected by the drive speed sensors 17 (see FIG. 4).

A speed command value for the motor 15 is generated based on the above total propulsion force and a turning torque. Respective speed command values of the motors 15 for turning the vehicle body 2a are generated based on the turning torque. The turning torque is calculated based on a value resulting from subtracting a yaw rate from the turning speed command value. The yaw rate is a turning speed, and is calculated based on the drive speeds of the drive wheels 14c and the wheel pitch between the drive wheels 14c. That is, the yaw rate is derived by dividing the difference between the drive speeds of the drive wheels 14c by the wheel pitch. In the calculation process for the turning torque, it is preferable to use a proportional control (P control) of performing an adjustment proportional to the deviation between a current output value and a target value. Thereby, it is possible to simplify the calculation process for the turning torque. Further, in the embodiment, the external force that is used when the total propulsion force is calculated is not used when the turning torque is calculated. Since the external force is not used in the calculation of the turning torque, the turning control hardly receives the influence of the outside.

Then, a speed control for the motors 15 is executed based on the generated speed command values and the drive speeds of the drive wheels 14c. That is, the speed command values are generated for the drive wheels 14c, respectively, and the two generated speed command values are applied to the motors 15, respectively. In this speed control, for example, an already-known PID control can be used for improving responsiveness. The PID control is a control in which a feedback control (I control) for integral action and a feedback control (D control) for derivative action are added to the above P control.

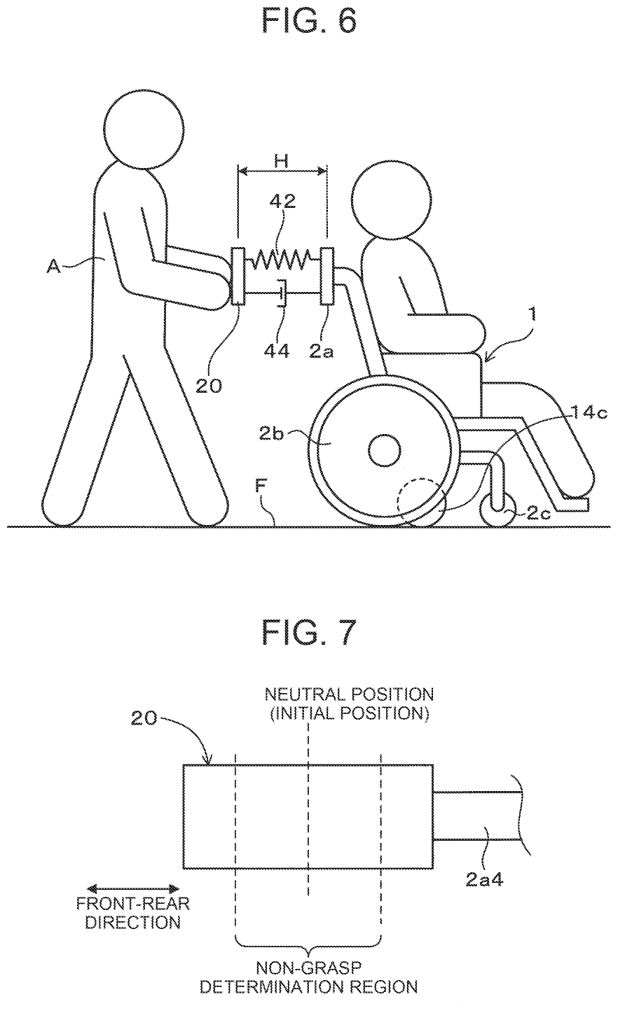

As shown in FIG. 6, when an operator A wants to move the electric wheelchair 1 along the road surface F, the operator A of the electric wheelchair 1 grasps and operates the respective grips 20 of the first operation units 10 by the right and left hands. At this time, the grips 20 move in the front-rear direction relative to the vehicle body 2a. The first operation units 10 give outputs depending on the movement of the grips 20, to the controller 18. The controller 18 generates the speed command values of the motors 15, based on the outputs given from the first operation units 10, and gives the speed command values to the drive circuits 34. In this way, the controller 18 controls the motors 15.

When the operator A grasps the grips 20 and performs an operation to push the grips 20 forward, the motors 15 are controlled such that the drive wheels 14c assist the forward movement action of the electric wheelchair 1. Further, when the operator A grasps the grips 20 and performs an operation to pull the grips 20 rearward, the motors 15 are controlled such that the drive wheels 14c assist the rearward movement action of the electric wheelchair 1. In contrast, in the case of a non-grasp state in which the operator A does not grasp the grips 20 or in the case where the operator A does not operate the grips 20 from the neutral position in the front-rear direction, the motors 15 are controlled such that the drive wheels 14c are not driven. In this way, the controller 18 determines whether the grips 20 are in an operation state or in a non-operation state by the operator A, or whether the grips 20 are in a grasp state or in the non-grasp state by the operator A, and controls the motors 15 depending on the operation state and the non-operation state or depending on the grasp state and the non-grasp state.

The outputs from the first operation units 10 indicate the displacement amounts of the grips 20 in the front-rear direction with respect to the vehicle body 2a. The controller 18 evaluates the respective displacement amounts of the grips 20 in the front-rear direction, based on the outputs of the first operation units 10. The displacement amount is the distance between a reference position (for example, the neutral position) previously set in a movable range of the grip 20 and the current position of the grip 20. In the case where the current position coincides with the reference position in the front-rear direction, the displacement amount is 0 (zero). The controller 18 discretely acquires the displacement amounts of the grips 20 with elapsed time, and stores the displacement amounts in the storage unit 40.

In the case where the operator A grasps and operates the first operation units 10 and the second operation unit 12, the controller 18 controls the drive mechanism 4 such that the motion of the vehicle body 2a corresponding to the displacement amounts is a motion that simulates a mechanical impedance characteristic. That is, the controller 18 controls the drive mechanism 4 such that such a motion that the grips 20 and the vehicle body 2a are connected by a virtual spring 42 and a virtual damper 44 is reproduced and a distance H between the grips 20 and the vehicle body 2a is constant, as shown in FIG. 6. In the embodiment, in the impedance control (see FIG. 5), a spring-damper model with the virtual spring 42 and damper 44 is used.

The control of the drive mechanism 4 that causes the distance H between the grips 20 and the vehicle body 2a to be constant includes such a control that the displacement amounts are maintained at 0 (zero) or a predetermined setting value. Thereby, the controller 18 controls the drive mechanism 4 such that the vehicle body 2a moves depending on the displacement amounts of the grips 20. For example, when the operator A moves forward and the grips 20 are pressed forward, the controller 18 controls the drive mechanism 4 such that the vehicle body 2a moves forward. Conversely, when the operator A moves rearward and the grips 20 are pulled rearward, the controller 18 controls the drive mechanism 4 such that the vehicle body 2a moves rearward. Further, in the case where the position of the grips 20 is the reference position (the neutral position), the controller 18 controls the drive mechanism 4 such that the vehicle body 2a stops.

### 9. Non-Grasp Determination Process

The processing unit 38 of the controller 18 performs a non-grasp determination process for the grips 20. Further, whether the grips 20 are in the grasp state is substantially the same as whether the grips 20 are in the operation state. Further, whether the grips 20 are in the non-grasp state is substantially the same as whether the grips 20 are in the non-operation state. That is, the operator operates the grips 20 while grasping the grips 20, and the operator stops the grasp of the grips 20 when stopping the operation of the grips 20. Therefore, in the present specification, “non-grasp determination” and “grasp determination” are also referred to as “non-operation determination” and “operation determination”, respectively, and “non-grasp state” and “grasp state” are also referred to as “non-operation state” and “operation state”, respectively.

In the embodiment, as shown in FIG. 7, a non-grasp determination region is set for the grips 20. The non-grasp determination region includes the neutral position (see FIG. 3A) that is the initial position of the grips 20. This non-grasp determination region is a non-operation determination region.

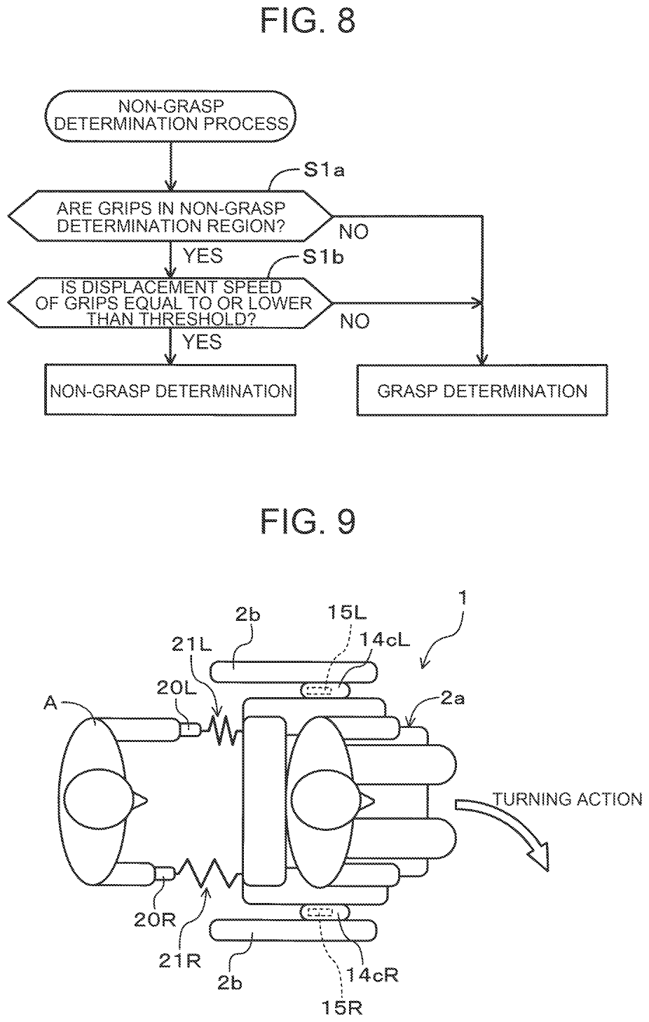

As shown in FIG. 8, the non-grasp determination process includes step S1a and step S1b.

Step S1a is a step of determining whether the grips 20 are in the non-grasp determination region. In the case where the grips 20 are in the non-grasp determination region (in the case of “Yes” in step S1a), the process proceeds to step S1b. On the other hand, in the case where the grips 20 are not in the non-grasp determination region (in the case of “No” in step S1a), the “grasp determination” for determining whether the grips 20 are in the grasp state is performed. The grasp determination is also the “operation determination” for determining whether the grips 20 are in the operation state.

Step S1b is a step of determining whether the displacement speed of the grips 20 is equal to or lower than a threshold. In the case where the displacement speed of the grips 20 is equal to or lower than the threshold (in the case of “Yes” in step S1b), the “non-grasp determination” indicating that the grips 20 are in the non-grasp state is made. The non-grasp determination is also the “non-operation determination” indicating that the grips 20 are in the non-operation state. On the other hand, in the case where the displacement speed of the grips 20 is higher than the threshold (in the case of “No” in step S1b), the “grasp determination” indicating that the grips 20 are in the grasp state is made. The threshold that is used in step S1b is previously stored in the storage unit 40.

### 10. Function Effect

Next, function effects of the above-described embodiment will be described.

With the electric wheelchair 1 in the above-described aspect, the controller 18 controls the first motor 15L and the second motor 15R so as to turn the vehicle body 2a, based on the difference between the displacement amount of the first grip 20L and the displacement amount of the second grip 20R and the difference between the rotation speed of the first drive wheel 14cL and the rotation speed of the second drive wheel 14cR.

As shown in FIG. 9, for example, in the case where the electric wheelchair 1 (the vehicle body 2a) is turned to the right on a flat road, the operator A performs the operation so as to push the first grip 20L forward and pull the second grip 20R rearward. The difference between the rotation speed of the first drive wheel 14cL and the rotation speed of the second drive wheel 14cR is zero before the turning, and therefore the controller 18 controls the first motor 15L and the second motor 15R based on the difference between the displacement amount of the first grip 20L and the displacement amount of the second grip 20R. Thereby, the electric wheelchair 1 is turned to the right, depending on the grip operation of the operator A. In this case, the turning operation can be stably performed.

Further, in the case where the electric wheelchair 1 (the vehicle body 2a) continues to be turned on the flat road, the difference between the rotation speed of the first drive wheel 14cL and the rotation speed of the second drive wheel 14cR has been already generated. Accordingly, the controller 18 controls the first motor 15L and the second motor 15R, based on the difference between the displacement amount of the first grip 20L and the displacement amount of the second grip 20R, in consideration of the difference between the rotation speed of the first drive wheel 14cL and the rotation speed of the second drive wheel 14cR. Thereby, the electric wheelchair 1 continues to be turned to the right depending on the grip operation of the operator A. Also in this case, the turning operation can be stably performed.

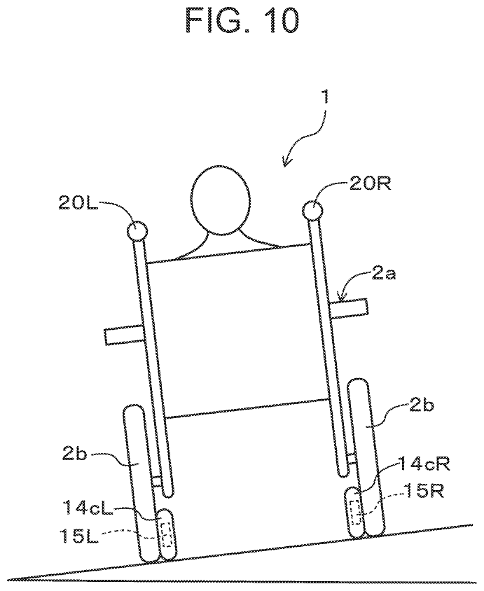

As shown in FIG. 10, for example, on a canted road having an inclination in which the right side is higher and the left side is lower, the vehicle body 2a is about to be turned to the left by the self-weight, due to the influence of the inclination. Thereby, the difference between the rotation speed of the first drive wheel 14cL and the rotation speed of the second drive wheel 14cR is generated. In the case of FIG. 10, there is a possibility that the rotation speed of the first drive wheel 14cL falls below the rotation speed of the second drive wheel 14cR. In this case, the controller 18 controls the first motor 15L and the second motor 15R, based on the difference between the displacement amount of the first grip 20L and the displacement amount of the second grip 20R, in consideration of the difference between the rotation speed of the first drive wheel 14cL and the rotation speed of the second drive wheel 14cR due to the influence of the canted road. Accordingly, even when the road surface is the canted road, the operation of the operator A can be suitably performed.

In the embodiment, as described above, the external force is not used in the calculation of the turning torque, for restraining the turning control from receiving the influence of the outside. Thereby, even at the time of the traveling on an inclined surface such as the canted road, it is possible to perform a control in which the influence of the inclined angle is restrained. Thereby, it is possible to restrain the operability for the operator A from decreasing in the case of the canted road.

Accordingly, with the above-described embodiment, it is possible to provide the electric wheelchair 1 having high operability.

The present disclosure has been described based on the above-described embodiment. However, it should be understood that the present disclosure is not limited to the forms and structures in the embodiment. The present disclosure includes various modifications, and includes various alterations in an equivalent range. In addition, various combinations and forms, and further other combinations and forms in which only one or more elements are added are also included in the category and idea scope of the present disclosure.

The case where the non-grasp determination is performed using the operation detection unit 21 has been exemplified in the above-described embodiment, but means other than the operation detection unit 21 may be used. As the other means, for example, there is a pressure sensor that is provided in the grip 20. For example, when the pressure detected by the pressure sensor is lower than a threshold, the determination of the non-grasp state is made, and when the pressure is equal to or higher than the threshold, the determination of the grasp state is made.

The case where the external force used when the total propulsion force is calculated is not used in the calculation of the turning torque has been exemplified in the above-described embodiment, but the external force may be used in the calculation of the turning force, as necessary.

In the electric wheelchair according to the aspect of the present disclosure, the controller may be configured to calculate an external force that the vehicle body receives from outside, based on a motor current of the first motor and a motor current of the second motor. The controller may be configured to generate the speed command value of the first motor and the speed command value of the second motor, by subtracting the turning torque and the external force from the propulsion force.

What is claimed is:

1. An electric wheelchair comprising:
a vehicle body;
a first drive wheel disposed on one of right and left sides of the vehicle body and configured to cause the vehicle body to travel;
a second drive wheel disposed on the other of the right and left sides of the vehicle body and configured to cause the vehicle body to travel;
a first motor configured to drive the first drive wheel;
a second motor configured to drive the second drive wheel;
a first grip disposed on the one of the right and left sides of the vehicle body so as to be grasped by an operator, and configured to be displaced in a front-rear direction of the vehicle body by operation of the operator;
a second grip disposed on the other of the right and left sides of the vehicle body so as to be grasped by the operator, and configured to be displaced in the front-rear direction of the vehicle body by operation of the operator;
a first operation detection unit configured to detect a position of the first grip in the front-rear direction;
a second operation detection unit configured to detect a position of the second grip in the front-rear direction;
a first rotation speed detection unit configured to detect a rotation speed of the first drive wheel;
a second rotation speed detection unit configured to detect a rotation speed of the second drive wheel; and
a controller configured to control the first motor and the second motor so as to turn the vehicle body, based on a difference between a displacement amount of the first grip and a displacement amount of the second grip and a difference between the rotation speed of the first drive wheel and the rotation speed of the second drive wheel.

2. The electric wheelchair according to claim 1, wherein
the controller is configured to:
generate a turning speed command value of the vehicle body, based on the difference between the displacement amount of the first grip and the displacement amount of the second grip;
calculate a yaw rate of the vehicle body, based on the difference between the rotation speed of the first drive wheel and the rotation speed of the second drive wheel;
calculate a turning torque of the vehicle body, based on a value resulting from subtracting the yaw rate from the turning speed command value;
generate a speed command value of the first motor and a speed command value of the second motor, based on the turning torque, the speed command value of the first motor and the speed command value of the second motor being speed command values for turning the vehicle body; and
control the first motor and the second motor, based on the speed command value of the first motor and the speed command value of the second motor, respectively.

3. The electric wheelchair according to claim 2, wherein
the controller is configured to:
calculate a propulsion force of the vehicle body, based on a sum of the displacement amount of the first grip and the displacement amount of the second grip; and
generate the speed command value of the first motor and the speed command value of the second motor, based on the propulsion force and the turning torque.

4. The electric wheelchair according to claim 3, wherein
the controller is configured to:
calculate an external force that the vehicle body receives from outside, based on a motor current of the first motor and a motor current of the second motor; and
generate the speed command value of the first motor and the speed command value of the second motor, by subtracting the turning torque and the external force from the propulsion force.
